(19) United States
(12) Patent Application Publication
(10) Pub. No.: US 2008/0042927 A1
(43) Pub. Date: Feb. 21, 2008

(54) Display apparatus and method of adjusting brightness thereof

(75) Inventors: Jun-ho Jung, Seoul (KR); Jun-ho Sung, Seoul (KR); Ki-bum Seong, Anyang-si (KR); Hanfeng Chen, Suwon-si (KR); Hyung-rae Kim, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/708,629

(22) Filed: Feb. 21, 2007

(30) Foreign Application Priority Data
Aug. 16, 2006 (KR) 2006-77324
Aug. 17, 2006 (KR) 2006-77763

(51) Int. Cl. G09G 3/14

(52) U.S. Cl. 345/39

(57) ABSTRACT

A display apparatus and a method of adjusting brightness thereof. The display apparatus displays an image, and includes a light emitting unit divided into a predetermined number of portion areas, so that brightness is adjusted according to the respective portion areas. A driving unit is connected to the light emitting unit to adjust brightness of each of the portion areas of the light emitting unit. A control unit calculates representative values to be applied in adjusting the brightnesses of the portion areas of the light emitting unit in response to an inputted image signal, compensates the representative values with a contrast enhancement method, and outputs the compensated representative values to the driving unit. The display apparatus adjusts the representative values to be applied for adjusting the brightnesses of the portion areas of a backlight and/or gamma-corrects the inputted image to compensate for increases and decreases in brightness.

### CROSS-REFERENCE TO RELATED APPLICATIONS

This application claims priority under 35 U.S.C. § 119(a) from Korean Patent Application Nos. 10-2006-0077324 and 10-2006-0077763, filed on Aug. 16, 2006 and Aug. 17, 2006, respectively, in the Korean Intellectual Property Office, the entire contents of which are incorporated herein by reference.

### BACKGROUND OF THE INVENTION

1. Field of the Invention

The present invention generally relates to a display apparatus and a method of adjusting brightness thereof. More particularly, the present invention relates to a display apparatus, which adjusts representative values to be applied for adjusting brightnesses of portion areas of a backlight unit, and/or gamma-corrects an inputted image so as to compensate for increases and decreases in brightness of the portion areas caused by interactions between the adjacent portion areas generated as a result of individual brightness adjustments for the portion areas, thereby efficiently improving a contrast ratio, and a method of adjusting brightness of the display apparatus.

2. Description of the Related Art

Generally, a display apparatus is used for displaying an image in a television set, a monitor of a notebook and a desktop computer, etc. Particularly, a liquid crystal display (LCD) apparatus should use light emitted from a separate light source because it does not generate the light by itself. Accordingly, the LCD apparatus has a backlight unit disposed at a rear surface of a liquid crystal panel to form a light source, and is configured so that it adjusts a transmissivity of light emitted from the backlight unit according to a motion of liquid crystal in the liquid crystal panel and thereby displays an image.

Recently, in order to represent an image which partially requires high luminance, the backlight unit adjusts brightness for each portion area thereof. For instance, in the case of an image, such as a fireworks display scene or an explosion scene, which partially requires the high luminance, the backlight unit brightly adjusts corresponding portion areas thereof, so that the image displayed on the LCD panel is more effectively represented.

However, as the backlight unit adjusts the brightness according to the portion areas, differences in brightness are generated between the portion areas, and due to the differences in brightness between the portion areas, increases and decreases in brightnesses come to exist in respective portion areas. Particularly, if the image is dark as a whole and partially bright, luminances of bright portion areas of the backlight unit are reduced under the influence of dark portion areas of the backlight unit, so that the entire image comes dark. As a result, it is difficult to obtain efficient contrast ratio.

Also, to adjust the brightness of the backlight unit according to the portion areas, individual brightness values are applied to the respective portion areas. At this time, the brightness values for respective portion areas use values calculated using mean values, weighted mean values or maximum values of brightnesses of corresponding portion area images as representative values, which represent the respective brightnesses of the portion areas. However, if the mean values are used as the representative values of the portion areas, brightness characteristics of the corresponding portion areas are reflected on the average, but a problem may occur, in the case that an inputted image is dark as a whole and partially bright, peak luminance of the image is deteriorated. Also, if the maximum values are used as the representative values of the portion areas, a problem may occur, in that luminance of an inputted image shows a sensitive reaction to noises.

### SUMMARY OF THE INVENTION

An aspect of the present invention is to provide a display apparatus, which adjusts representative values to be applied for adjusting brightnesses of respective portion areas of a backlight and/or gamma-corrects an inputted image to compensate for increases and decreases in brightness of the portion areas caused by interactions between adjacent portion areas generating as a result of individual brightness adjustments for the portion areas, thereby efficiently improving a contrast ratio, and a method of adjusting brightness of the display apparatus.

According to one aspect of an exemplary embodiment of the present invention, there is provided a display apparatus for displaying an image including a light emitting unit divided into a predetermined number of portion areas, so that brightness is adjusted according to the respective portion areas, a driving unit connected to the light emitting unit to adjust brightness of each of the portion areas of the light emitting unit, and a control unit to calculate representative values to be applied in adjusting the brightnesses of the portion areas of the light emitting unit, respectively, in response to an inputted image signal, to compensate the representative values with a contrast enhancement method, and to output the compensated representative values to the driving unit.

The contrast enhancement method may be applied to representative value within a predetermined range.

Also, the contrast enhancement method may include a histogram equalization.

The histogram equalization may use the following formula:

$$h ( i ) = \frac{{G}_{max}}{{N}_{t}} \times H ( i )$$

wherein h(i) is a brightness value of a portion area to which the histogram equalization is applied, Nt is the total number of portion areas, H(i) is the number of portion areas in which a brightness value corresponds to 0˜i, and Gmax is a maximum brightness value of the light emitting unit.

The contrast enhancement method may include a bi-histogram equalization.

The contrast enhancement method may include a stretch.

The control unit may output filtering the compensated representative values.

Also, the filtering process may include a spatial filtering or a temporal filtering.

According to another aspect of an exemplary embodiment of the present invention, there is provided a method of adjusting brightness of a display apparatus including calculating representative values for adjusting brightnesses of portion areas of a light emitting unit, respectively, in response to an inputted image signal, compensating the representative values with a contrast enhancement method, and applying the compensated representative values in adjusting the brightness of each of the portion areas.

According to still another aspect of an exemplary embodiment of the present invention, there is provided a backlight apparatus including a light emitting unit divided into a predetermined number of portion areas, so that brightness is adjusted according to the respective portion areas, a driving unit connected to the light emitting unit to adjust brightness of each of the portion areas of the light emitting unit, and a control unit to calculate representative values to be applied in adjusting the brightnesses of the portion areas of the light emitting unit, respectively, in response to an inputted image signal, to compensate the representative values with a contrast enhancement method, and to output the compensated representative values to the driving unit.

According to another aspect of an exemplary embodiment of the present invention, there is provided a display apparatus including a backlight unit having a light emitting unit divided into a predetermined number of portion areas, so that brightness is adjusted according to the portion areas, a display unit having a liquid crystal panel and a liquid crystal panel driving unit, and a control unit to calculate representative values for adjusting the brightnesses of the portion areas of the light emitting unit, respectively, in response to an inputted image signal and output the calculated representative values to the backlight unit, and to gamma-correct the inputted image signal to compensate for increases and decreases in brightness of the portion areas caused by differences in brightness between adjacent portion areas and output the gamma-corrected image signal to the display unit.

The control unit may combine the inputted image signal and the gamma-corrected image signal and outputs the combined image signal to the display unit.

The control unit may gamma-correct applying an individual gamma curve to each of image signals for red, green and blue.

The control unit may output compensating the representative values with a contrast enhancement method.

The contrast enhancement method may include a histogram equalization, a stretch, or a bi-histogram equalization.

The control unit may output spatially filtering or temporally filtering the compensated representative values.

According to also other aspect of an exemplary embodiment of the present invention, there is provided a method of adjusting brightness of a display apparatus including: calculating representative values for adjusting brightnesses of portion areas of a backlight, respectively, in response to an inputted image signal, gamma-correcting the inputted image signal to compensate for increases and decreases in brightness of the portion areas caused by differences in brightness between adjacent portion areas, and outputting the gamma-corrected image signal to a display unit.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

These and/or other aspects and advantages of certain embodiments of the present invention will become apparent and more readily appreciated from the following description of the embodiments, taken in conjunction with the accompanying drawings of which:

FIG. 1 is a block diagram schematically exemplifying an entire construction of a display apparatus in accordance with an exemplary embodiment of the present invention;

FIGS. 2A and 2B are views exemplifying a case in which a histogram equalization is applied to adjust brightnesses of portion areas of a light emitting unit of the display apparatus in accordance with the exemplary embodiment of the present invention;

FIG. 3 is a view exemplifying a case in which a stretch is applied to adjust the brightnesses of the portion areas of the light emitting unit of the display apparatus in accordance with the exemplary embodiment of the present invention;

FIG. 4 is a flowchart exemplifying a process of adjusting brightness of the display apparatus in accordance with the exemplary embodiment of the present invention;

FIG. 5 is a view exemplifying a state, which gamma-corrects an inputted image in a display apparatus in accordance with another exemplary embodiment of the present invention; and

FIG. 6 is a flowchart exemplifying a process of adjusting brightness of the display apparatus in accordance with the another exemplary embodiment of the present invention.

### DETAILED DESCRIPTION OF EXEMPLARY EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

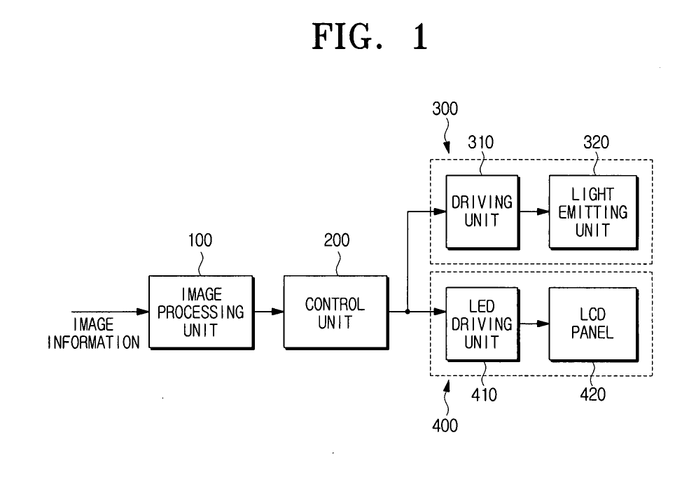

FIG. 1 is a block diagram schematically exemplifying an entire construction of a display apparatus in accordance with an exemplary embodiment of the present invention.

An image processing unit 100 processes image information, and outputs image data divided into red R, green G, and blue B image signals to a control unit 200.

The control unit 200 receives the image data from the image processing unit 100, calculates representative values to be applied in adjusting brightnesses of individual portion areas of a light emitting unit 320, and outputs the calculated representative values to a backlight unit 300. The backlight unit 300 includes a driving unit 310, and a light emitting unit 320 in which brightness is adjusted according to the portion areas.

The light emitting unit 320 is made up of a plurality of light emitting elements, and is divided into a predetermined number of portion areas. Light emitting diodes (LED) can be used as the light emitting elements. However, the present invention is not limited to a backlight unit having LEDs. For instance, the present invention is also applicable to a backlight unit having field emission displays (FED), surface-conduction electron-emitter displays (SED) or the like in the same principle and construction.

A predetermined number of portion areas are formed, so that the brightness of the light emitting unit can be partially controlled. For example, the light emitting unit can be formed by 64 portion areas, which are divided into 8 by 8.

The driving unit 310 is connected to the light emitting unit 320 to control the brightness of each of the portion areas of the light emitting unit 320. The driving unit 310 adjusts the brightness of each of the portion areas of the light emitting unit 320 in a pulse width modulated (PWM) method or a linear driving method.

The control unit 200 calculates the representative values for adjusting the brightnesses of each of the portion areas of the light emitting unit 320, in response to the image signals of the image data inputted from the image processing unit 100.

The representative values are calculated choosing mean values or maximum values of gray levels of image pixels corresponding to the portion areas, or applying a histogram method or the like thereto. At this time, to determine a gray level Y to each of the image pixels from the inputted image signals, a maximum value among three gray levels of R, G and B is chosen, as in the following formula 1. If the maximum value among the three gray levels of R, G and B is not chosen, color distortion can occur.

Y=max(R,G,B) [Mathematical formula 1]

According to the exemplary embodiment of the present invention, after the representative values of the portion areas are calculated in the various methods as described above using values of the gray levels Y, they are compensated by a contrast enhancement method. The contrast enhancement method is a method which increases a contrast ratio through a linear or non-linear conversion. As the contrast enhancement methods, there are a histogram equalization, a stretch, and a bi-histogram equalization.

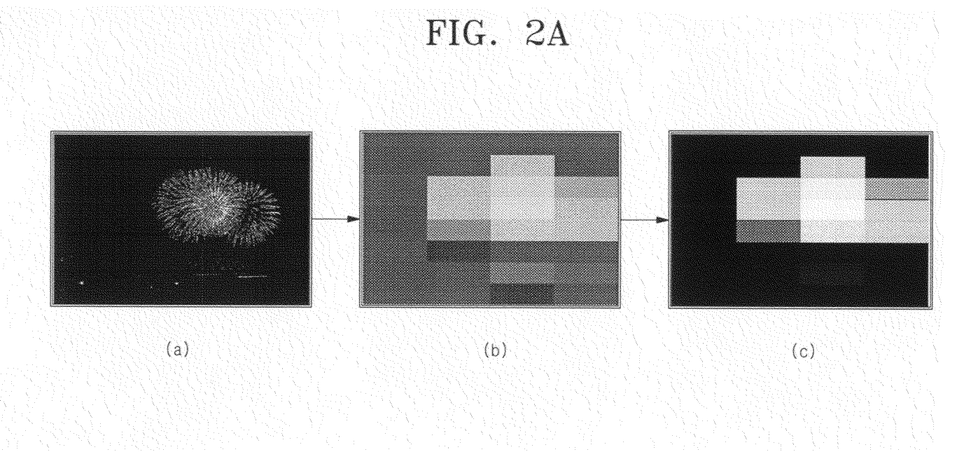

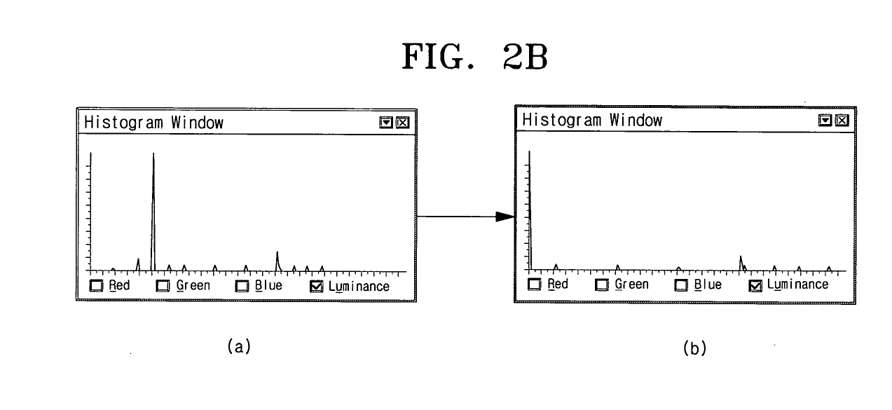

FIGS. 2A and 2B exemplify a case in which the histogram equalization is applied as the contrast enhancement method. In FIG. 2A, (a) illustrates an inputted image of a fireworks display scene, (b) illustrates a result in which representative values calculated using mean values of gray levels are applied for adjusting brightnesses of the portion areas, and (c) illustrates a result in which the histogram equalization is applied to (b). It can be confirmed that the (c) to which the histogram equalization is applied has bright portion areas brighter and dark portion areas darker than those of the screen (b) prior to applying the histogram equalization thereto.

In FIG. 2B, (a) illustrates a histogram distribution on the basis of the representative values of the portion areas prior to applying the histogram equalization thereto, and thus corresponds to the (b) of FIG. 2A. In FIG. 2B, (b) illustrates a histogram distribution after applying the histogram equalization to the representative values of the portion areas, and thus corresponds to the (c) of FIG. 2A. As illustrated in the drawings, it can be appreciated that the (b) of FIG. 2B to which the histogram equalization is applied has intervals between brightnesses of the portion areas on an X-axis, which are enlarged as compared with the (a) of FIG. 2B. That is, as the histogram equalization is applied, the intervals between the brightness values of the portion areas are enlarged, so that portion areas with approximate brightness values, i.e., approximate representative values, can be definitely distinguished from one another, thereby allowing the contrast ratio to increase.

The following mathematic formula 2 is a formula which is used for converting the (b) to the (c) of FIG. 2A by applying the histogram equalization as described above.

$$h ( i ) = \frac{{G}_{max}}{{N}_{t}} \times H ( i ) \qquad [ Mathematical formula 2 ]$$

Here, h(i) is a brightness value of a portion area to which the histogram equalization is applied, Nt is the total number of the portion areas, H(i) is the number of portion areas in which a brightness value corresponds to 0˜i, and Gmax is a maximum brightness value of the light emitting unit. The H(i), which is the accumulated number of the portion areas on a histogram when the brightness value is i, is the same as the number of portion areas in which the brightness value corresponds to 0˜i. For instance, in the backlight unit having 64 portion areas, which are divided into 8 by 8, and using 8 bit signals, the Nt is 64, and the Gmax comes to 255. Here, the brightness values correspond to the representative values of the portion areas.

Referring to the mathematic formula 2, in the exemplary embodiment of the present invention, the histogram equalization, which is an image processing method, is applied, wherein all the portion areas are handled as a single image and each of the portion areas is handled as each of the image pixels.

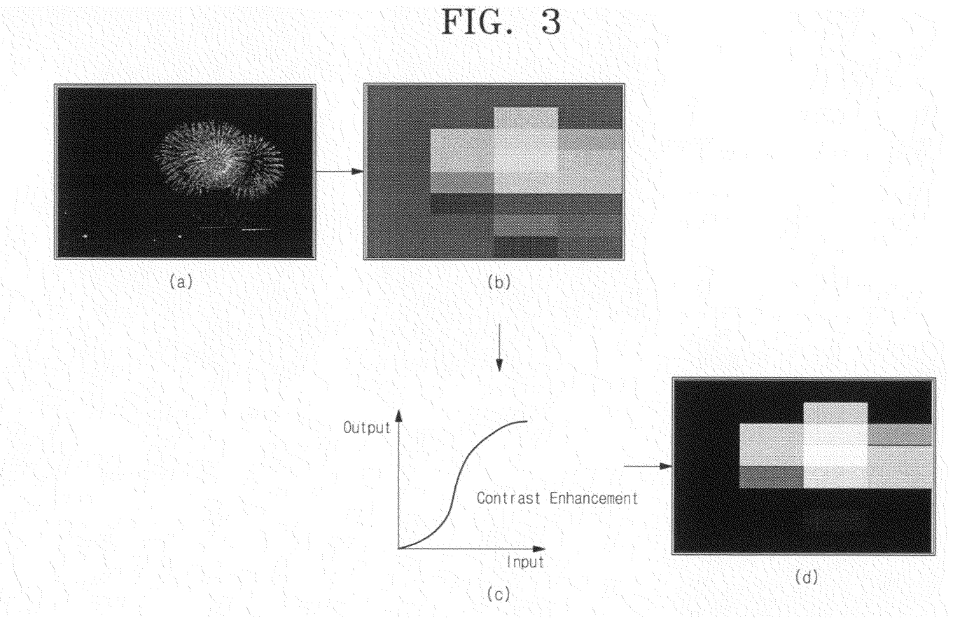

FIG. 3 exemplifies a case in which the stretch is applied as the contrast enhancement method. In FIG. 3, (b) illustrates a result in which representative values calculated on the basis of an inputted image (a) are applied, and (d) illustrates a result in which a stretching curve (c) is applied to the (b) and thus converted. With the stretch, dark portion areas become darker and bright portion areas come brighter, thereby allowing the contrast radio to be considerably improved.

The contrast enhancement method as described above can be applied to representative values within a predetermined range among the representative values to be applied to the portion areas. That is, in a portion area of the portion areas, a representative value to which the contrast enhancement method is not applied is used for adjusting the brightness of the portion area.

The control unit 200 uses the representative values to which the contrast enhancement method is applied or not applied, for adjusting the brightness of the portion areas, respectively.

Also, according to characteristics of the image, the control unit 200 uses a spatial filter or a temporal filter. For instance, in case that bright images are laid across several portion areas in different sizes, since the representative values are calculated according to the respective portion areas, differences in brightness between the portion areas are enlarged, so that stepped difference in gradation is generated in the vicinity of border lines between the portion areas of the corresponding images. In this case, if the spatial filter is used, adjacent portion areas can be artlessly represented.

In addition, in case of motion images in which brightness is momentarily changed, the backlight unit can be flicked off and on due to abrupt increases in the representative values of the portion areas. In this case, the temporal filter is used.

Besides the spatial and temporal filters, a low pass filter can be used. Since the filters as described above are known in the art, detailed description on constructions and operations thereof will be omitted for clarity and conciseness.

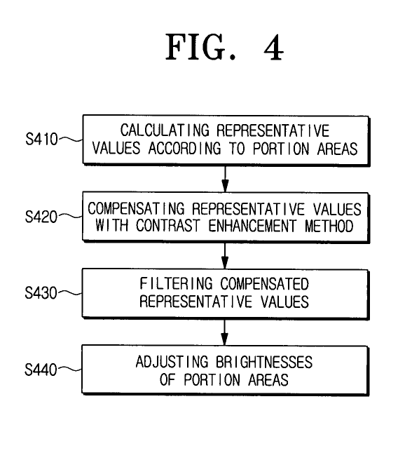

FIG. 4 is a flowchart exemplifying a process of adjusting brightness of the display apparatus in accordance with the exemplary embodiment of the present invention;

The display apparatus of the exemplary embodiment of the present invention calculates representative values for adjusting brightnesses of the respective portion areas of the light emitting unit in response to inputted image signals (S410). The representative values are calculated using mean values, maximum values, histogram distribution, or the like of gray levels of an image inputted to the portion areas, respectively. The representative values are compensated by a contrast enhancement method (S420). As the contrast enhancement method, a histogram equalization, a stretch, a bi-histogram equalization or the like is used. The compensated representative values are filtered (S430), and are applied for adjusting the brightnesses of the portion areas (S440). Here, the contrast enhancement method may be applied only to representative values within a predetermined range.

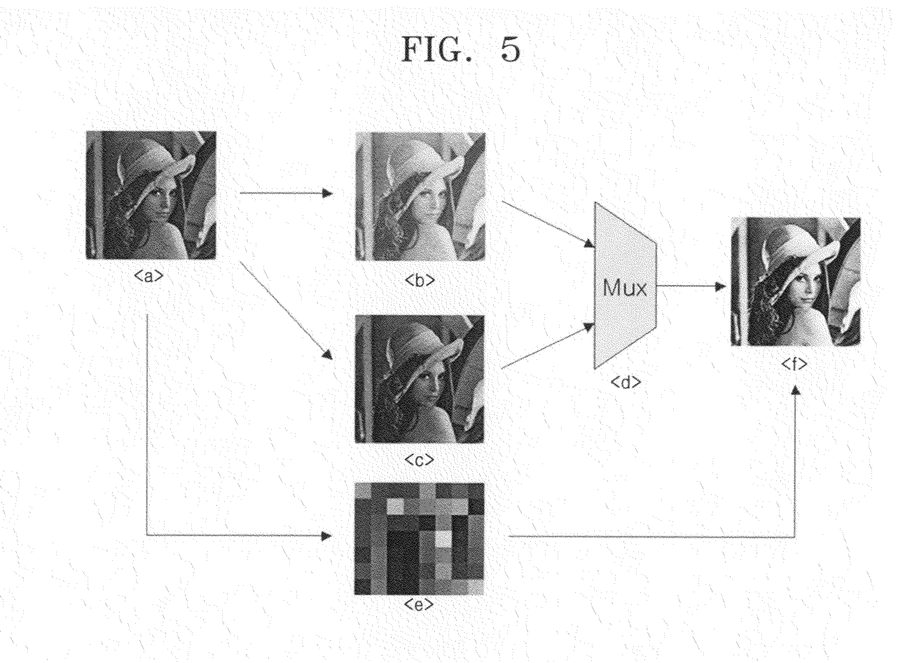

FIG. 5 exemplifies a state which gamma-corrects an inputted image in a display apparatus in accordance with another exemplary embodiment of the present invention. Since the display apparatus of the another exemplary embodiment of the present invention has the same constructions and functions as those of the display apparatus of FIG. 1 except for a control unit 200, it will be explained with reference to FIG. 1.

The control unit 200 calculates representative values for adjusting brightnesses of the portion areas of the light emitting unit in response to inputted image signals and outputs the calculated representative values to the backlight unit. In addition, the control unit 200 gamma-corrects the inputted image signals to compensate for increases and decreases in brightness of the portion areas caused by differences in brightness between adjacent portion areas and outputs the gamma-corrected image signal to a display unit 400. To be more specific, as the brightness can be adjusted according to the respective portion areas, differences in brightness are generated between the portion areas of a backlight unit 300, and thereby increases and decreases in brightnesses come to exist in adjacent portion areas. To compensate the increases and decreases in brightnesses, the control unit 200 outputs gamma-correcting the inputted image signals to the display unit 400.

In FIG. 5, (a) illustrates an inputted image, and (e) illustrates a light emitting unit 320 of the backlight unit 300 in which representative values calculated corresponding to the inputted image (a) are applied to the portion areas, respectively. Also, (b) illustrates an image, which is gamma-corrected to increase brightness, and (c) illustrates an image, which is not separately corrected, but bypassed. The image of the (c) is the same as the originally inputted image (a). The gamma-corrected image (b) signals can be combined with the originally inputted image (a) signals, which is not gamma-corrected, through a multiplexer at (d). In FIG. 5, (f) illustrates an image, which is displayed on a liquid crystal display (LCD) panel 420 on the basis of the light emitting unit 320 in which the representative values are applied and the gamma-corrected image signals (or the gamma-corrected image signals combined with the inputted image signals prior to gamma-correcting).

As described above, according to the display apparatus of the another exemplary embodiment of the present invention, the representative values are applied according to the portion areas in response to the inputted image, and the image signals gamma-corrected to compensate for increases and decreases in brightness of the portion areas are outputted to a LCD driving unit 410 to display the image (f) on the LCD panel 420. Accordingly, the image (f) displayed on the LCD panel 420 comes to have a better contrast ratio than that of the inputted image (a), so that it can be more clearly displayed.

Also, the control unit 200 can gamma-correct applying individual gamma curves, such as R=r^{1/γ},G=g^{1/γ}, and B=b^{1/γ}, to the image signals for red, green and blue. In this case, additional effects, such as a color temperature correction or a color area conversion, can be obtained, thereby allowing colors to be more clearly represented.

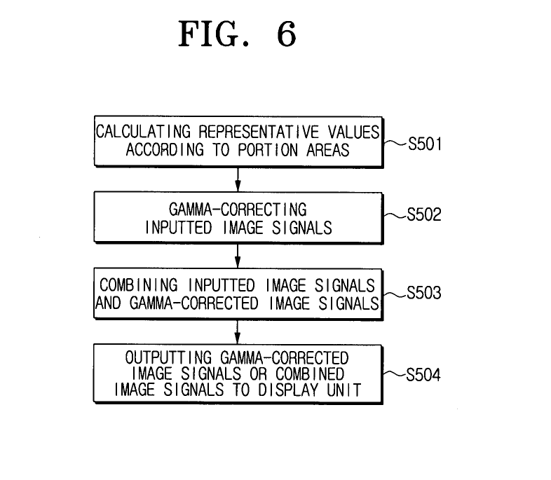

FIG. 6 is a flowchart exemplifying a process of adjusting brightness of the display apparatus in accordance with the another exemplary embodiment of the present invention. The control unit 200 calculates representative values for adjusting brightnesses of the portion areas of the light emitting unit, respectively (S501). Subsequently, the control unit 200 gamma-corrects inputted image signals to compensate for increases and decreases in brightness of the portion areas caused by differences in brightness between adjacent portion areas (S502). The gamma-corrected image signals are combined with the inputted image signals (S503). The gamma-corrected image signals, or the gamma-corrected image signals combined with the inputted image signals, are outputted to the display unit (S504), and the LCD panel of the display unit displays an image along with the light emitting unit 320 to which the representative values are applied.

Also, according to the process of adjusting the brightness of the display apparatus in accordance with the another exemplary embodiment of the present invention, the representative values to be applied for adjusting the brightness of the portion areas can be adjusted using a contrast enhancement method. In this case, the contrast enhancement method can use any one of a histogram equalization, a stretch, and a bi-histogram equalization.

As described above, the present invention is explained as two exemplary embodiments, which compensate for increases and decreases in brightnesses, or decreases in peek luminance generating in respective portion areas as the brightnesses of the portion areas are individually adjusted. To improve the contrast ratio, the two exemplary embodiments can be applied individually, or in combination with each other.

As is apparent from the foregoing description, according to the exemplary embodiments of the present invention, the display apparatus and the method of adjusting brightness thereof adjust the representative values to be applied for adjusting the brightnesses of the portion areas of the backlight unit, respectively, and/or gamma-correct the inputted image so as to compensate for the increases and decreases in brightness of the portion areas caused by the interactions between the adjacent portion areas generating as a result of the individual brightness adjustments for the portion areas. Accordingly, the display apparatus and the method of adjusting a brightness thereof according to the exemplary embodiments of the present invention can efficiently improve the contrast ratio.

Although representative embodiments of the present invention have been shown and described in order to exemplify the principle of the present invention, the present invention is not limited to the specific embodiments described. It will be understood that various modifications and changes can be made by one skilled in the art without departing from the spirit and scope of the invention as defined by the appended claims. Therefore, it shall be considered that such modifications, changes and equivalents thereof are all included within the scope of the present invention.

What is claimed is:

1. A display apparatus for displaying an image comprising:
a light emitting unit divided into a predetermined number of portion areas, so that brightnesses of the respective portion areas can be adjusted;
a driving unit connected to the light emitting unit to adjust the brightness of each of the portion areas of the light emitting unit; and
a control unit which calculates representative values to be applied in adjusting the brightnesses of the portion areas of the light emitting unit in response to an inputted image signal, which compensates the representative values with a contrast enhancement method, and which outputs the compensated representative values to the driving unit.

2. The display apparatus as claimed in claim 1, wherein the contrast enhancement method is applied to representative values within a predetermined range.

3. The display apparatus as claimed in claim 1, wherein the contrast enhancement method comprises a histogram equalization.

4. The display apparatus as claimed in claim 3, wherein the histogram equalization uses the following formula:
$$h ( i ) = \frac{{G}_{max}}{{N}_{t}} \times H ( i )$$
wherein h(i) is a brightness value of a portion area to which the histogram equalization is applied, Nt is the total number of portion areas, H(i) is the number of portion areas in which a brightness value corresponds to 0˜i, and Gmax is a maximum brightness value of the light emitting unit.

5. The display apparatus as claimed in claim 1, wherein the contrast enhancement method comprises a bi-histogram equalization.

6. The display apparatus as claimed in claim 1, wherein the contrast enhancement method comprises a stretch.

7. The display apparatus as claimed in claim 1, wherein the control unit outputs filtering for the compensated representative values.

8. The display apparatus as claimed in claim 7, wherein the filtering comprises at least one of a spatial filtering and a temporal filtering.

9. A method of adjusting brightness of a display apparatus comprising:
calculating representative values for adjusting brightnesses of portion areas of a light emitting unit in response to an inputted image signal;
compensating the representative values with a contrast enhancement method; and
applying the compensated representative values to adjust the brightness of each of the portion areas.

10. The method as claimed in claim 9, wherein the contrast enhancement method is applied to representative values within a predetermined range.

11. The method as claimed in claim 9, wherein the contrast enhancement method comprises a histogram equalization.

12. The method as claimed in claim 11, wherein the histogram equalization uses the following formula:
$$h ( i ) = \frac{{G}_{max}}{{N}_{t}} \times H ( i )$$
wherein h(i) is a brightness value of a portion area to which the histogram equalization is applied, Nt is the total number of portion areas, H(i) is the number of portion areas in which a brightness value corresponds to 0˜i, and Gmax is a maximum brightness value of the light emitting unit.

13. The method as claimed in claim 9, wherein the contrast enhancement method comprises a bi-histogram equalization.

14. The method as claimed in claim 9, wherein the contrast enhancement method comprises a stretch.

15. The method as claimed in claim 9, further comprising:
filtering the compensated representative values.

16. The method as claimed in claim 15, wherein the filtering comprises at least one of spatially filtering and temporally filtering the compensated representative values.

17. A backlight apparatus comprising:
a light emitting unit divided into a predetermined number of portion areas, so that brightnesses of the respective portion areas can be adjusted;
a driving unit connected to the light emitting unit to adjust the brightness of each of the portion areas of the light emitting unit; and
a control unit which calculates representative values to be applied in adjusting the brightnesses of the portion areas of the light emitting unit in response to an inputted image signal, which compensates the representative values with a contrast enhancement method, and which outputs the compensated representative values to the driving unit.

18. A display apparatus comprising:
a backlight unit having a light emitting unit divided into a predetermined number of portion areas, so that brightnesses of the individual portion areas can be adjusted;
a display unit having a liquid crystal panel and a liquid crystal panel driving unit; and
a control unit which calculates representative values for adjusting the brightnesses of the portion areas of the light emitting unit in response to an inputted image signal and output the calculated representative values to the backlight unit, and which gamma-corrects the inputted image signal to compensate for increases and decreases in brightness of the portion areas caused by differences in brightness between adjacent portion areas and which outputs the gamma-corrected image signal to the display unit.

19. The display apparatus as claimed in claim 18, wherein the control unit combines the inputted image signal and the gamma-corrected image signal and outputs the combined image signal to the display unit.

20. The display apparatus as claimed in claim 18, wherein the control unit gamma-corrects by applying an individual gamma curve to red, green and blue image signals.

21. The display apparatus as claimed in claim 18, wherein the control unit compensates the representative values with a contrast enhancement method.

22. The display apparatus as claimed in claim 21, wherein the contrast enhancement method comprises one of a histogram equalization, a stretch and a bi-histogram equalization.

23. The display apparatus as claimed in claim 18, wherein the control unit at least one of spatially filters and temporally filters the compensated representative values.

24. A method of adjusting brightness of a display apparatus comprising:
calculating representative values for adjusting brightnesses of portion areas of a backlight in response to an inputted image signal;
gamma-correcting the inputted image signal to compensate for increases and decreases in brightness of the portion areas caused by differences in brightness between adjacent portion areas; and
outputting the gamma-corrected image signal to a display unit.

25. The method as claimed in claim 24, further comprising:
combining the inputted image signal and the gamma-corrected image signal.

26. The method as claimed in claim 24, wherein the gamma-correcting the inputted image signal comprises gamma-correcting by applying an individual gamma curve to each of red, green and blue image signals.

27. The method as claimed in claim 24, further comprising:
compensating the representative values with a contrast enhancement method.

28. The method as claimed in claim 27, wherein the contrast enhancement method comprises one of a histogram equalization, a stretch and a bi-histogram equalization.

29. The method as claimed in claim 24, further comprising:
at least one of spatially filtering and temporally filtering the compensated representative values.
